(19) United States
(12) Patent Application Publication
(10) Pub. No.: US 2017/0197310 A1
(43) Pub. Date: Jul. 13, 2017

(54) Machine And Method For Operating A Machine

(71) Applicant: KUKA Roboter GmbH, Augsburg (DE)

(72) Inventors: Andreas Aurnhammer, Munchen (DE); Stefan Durndorfer, Augsburg (DE); Andreas Hagenauer, Friedberg (DE); Manfred Huttenhofer, Meitingen (DE)

(21) Appl. No.: 15/324,493

(22) PCT Filed: Jul. 7, 2015
(86) PCT No.: PCT/EP2015/065461

§ 371 Date: Jan. 6, 2017

(30) Foreign Application Priority Data
Jul. 8, 2014 (DE) 10 2014 213 262.2

(51) Int. Cl. B25J 9/16

(52) U.S. Cl. CPC B25J 9/1664; B25J 9/1666; G05B 2219/35472; G05B 2219/40497

(57) ABSTRACT

A controllable machine comprises a mechanism having at least two components arranged relative to one another and movable relative to one another with respect to an axis by at least one drive, a memory, and a control device coupled to the at least one drive. The control device controls the at least one drive to move the mechanism in a first operating mode such that the mechanism moves along a movement path and records the movement path in the memory. The control device controls the at least one drive on the basis of the movement path recorded in the memory in a second operating mode such that the mechanism moves along the movement path recorded in the memory.

### CROSS-REFERENCE

This application is a national phase application under 35 U.S.C. §371 of International Patent Application No. PCT/EP2015/065461, filed Jul. 7, 2015 (pending), which claims the benefit of German Patent Application No. DE 10 2014 213 262.2 filed Jul. 8, 2014, the disclosures of which are incorporated by reference herein in their entirety.

### TECHNICAL FIELD

The invention relates to a machine that has a control device and a mechanism with at least two components arranged relative to one another, which by use of a machine drive controlled by the control device can be moved relative to each other with respect to an axis, and a method for operating such a machine.

### BACKGROUND

An example of such a machine is an industrial robot. In general, industrial robots are handling machines, which are set up for automatic handling of objects with tools for that purpose and which are programmable in several movement axes, in particular with regard to orientation, position, and workflow. Industrial robots usually have a robotic arm with several links arranged one after another and programmable controls (control devices), which control or regulate the drives of the industrial robot, such as by feedback control, during automatic operation of the industrial robot for the movement courses of the robotic arm. For this purpose, corresponding calculation programs, what are called user programs, run on the control devices. The drives are for example electrical drives.

It can also be provided that the robotic arm can be moved by a manual method using a programmable hand device (manual operation). The programmable manual device is connected with the control device and includes a command input means. When the command input means is activated, the control device controls the drives of the industrial robot for the movement of the robotic arm in such a way that for example a so-called tool center point performs the corresponding movement upon activation of the command input means. The command input means include for example shift paddles and/or a joystick. Thereby a simultaneous operation of the robotic arm or its tool center points is possible in up to 3 or 6 directions or moments of freedom.

If the industrial robot is located for example inside a spatially relatively narrow application, for example based on the execution of a user program or based on a manual method, it may become necessary to move the robotic arm or its tool center point out of this relatively narrow environment, that is, with the least possible risk of collision or no risk at all.

Using the manual method for such a free movement out of a narrow environment without risk is relatively time-consuming.

Alternatively, one may attempt through backward directed performance of the user program to move the robotic arm automatically out of the critical area. In this way the precisely forward traveled movement path of the robotic arm, directed by the user program running on the control device, travels in the reverse movement direction. This is also relatively time-consuming.

The object of this invention is to provide an improved machine and an improved procedure for operating such a machine, which has a control device and a mechanism with at least two components arranged in relation to one another that are controlled by a machine drive and are movable relative to one another through the control device along an axis.

The object of the invention is solved by a machine that has a mechanism that has at least two components arranged relative to one another that by at least one drive of the machine are movable relative to one another along an axis, a memory, and a control device coupled with the drive, which is arranged in a first operating mode to control a drive for moving the mechanism in such a way that the mechanism, in particular a point arranged and distinguished by the mechanism, moves along a movement path, in the first operating mode to designate the movement path in the memory, and in a second operating mode to control at least one drive based on the movement path designated in the memory in such a way that the mechanism, in particular the distinguished point, moves along the movement path designated in the memory.

The object of the invention is also solved by a procedure for operating a machine that comprises a control device and a mechanism, which comprises at least two components arranged relative to one another, which are movable relative to one another by at least one machine drive with relation to an axis, comprising the following procedural steps:
in a first operating mode of the machine, controlling the at least one drive using the control device in a way that the mechanism, in particular a point designated and arranged by the mechanism along a travel path, moves, and simultaneously records the movement path in a memory, and
in a second operating mode of the machine, controlling the at least one drive using the control device based on the movement path recorded in the memory in such a way that the mechanism moves along the movement path recorded in the memory.

The inventive machine is in particular an electric machine, that is, it's at least one drive is in particular an electric drive. The mechanism comprises in particular more than two components, which are movable relative to each other along axes using an assigned drive, in particular using an electric drive. The mechanism can for example be arranged as a closed kinematic, for example as a delta kinematic or a hexapod.

The machine is preferentially set up as an industrial robot, which as a mechanism has a robotic arm, which comprises several links connected by joints behind one another as the at least two components. In this case, the distinguished point is a tool center point assigned to the robotic arm.

The inventive machine comprises at least both components, which are movable relative to one another along the axis. The axis is for example a rotating axis or a linear axis. In the case of the industrial robot, it comprises the robotic arm, whose links can be moved using the drives. The drives are in particular electric drives and preferentially drives controlled electrically. At a minimum the electric motors of these electric drives are preferentially fastened in or on the robotic arm.

The control device of the inventive machine, in particular of the inventive industrial robot, is set up in the first operating mode to move the mechanism, in particular the robotic arm, along a movement path.

In particular the control device in the first operating mode controls the robotic arm in such a way that a tool center point assigned to the robotic arm moves along the movement path. In a second operating mode the control device controls the drives on the basis of the movement path recorded in the memory in such a way that the tool center point moves along the movement path recorded in the memory.

In the first operating mode, this may involve for example an automatic operation of the machine, in particular of the industrial robot, in which the control device, based on a calculation program running on the control device, on what is called a user program, controls at least one drive automatically, whereby the mechanism or the distinguished point, in particular the robotic arm or its tool center point, moves along the movement path.

The first operating mode, however, can also present a manual operation of the machine or of the industrial robot. In this case, the inventive machine comprises a manual input apparatus that is coupled with or couplable with the control device. Such an input apparatus is for example a manual programmable device. Appropriate input means are for example shift paddles and/or a joystick. In the manual operation, the control device controls the at least one drive for the movement of the mechanism along the movement path corresponding to manual operation of the input means. Thereby it is possible to operate the mechanism manually, in particular the robotic arm, using the input apparatus.

It is preferable to plan a memory as a dynamic memory. The memory can be arranged as a LIFO memory (last in-first out).

Especially preferred is a memory set up as a ring buffer. A ring buffer is also called a ring memory. The memory set up as a ring buffer is preferentially configurable, for example with configured or predefined length.

Inventively, it is planned that the inventive machine, in particular the inventive industrial robot, preferentially its control device, during the first operating mode operates in particular quasi-continuously or in discrete steps of the mechanism or its distinguished point, in particular by the robotic arm or its tool center point, along the laid movement path recorded in the memory. Thereby for example the currently traveled path is written to the memory quasi-continuously by the mechanism or by the robotic arm, including any possible additional axes that are present, in a relatively tight pattern. In particular the recorded movement path comprises information about the recorded movement point moved via the mechanism or via the tool center points of the robotic arm, in particular including information about the status, that is, the positions and orientations of the distinguished point and of the tool center points during its movement. The recorded movement path can also comprise information about the axis settings of the axes of the robotic arm, that is, information about the relative settings of the individual links of the robotic arm relative to one another during the movement.

Thereby the actual laid down movement path of the mechanism, in particular of the robotic arm, is stored in the memory during the first operating mode up to a certain length, which is given or predefined by the size of the memory, for example the length of the ring buffer.

If the inventive machine is operated in the second operating mode, then the control device controls the at least one drive based on the movement path stored in the memory. In that way it is preferentially possible that the control device can control in the second operating mode the at least one drive based on the movement path recorded in the memory of in such a way that the mechanism or its distinguished point, in particular the robotic arm or its tool central point, moves along the recorded movement path against the direction of movement with which the mechanism, in particular the robotic arm, was moved during the first operating mode.

If for example the inventive industrial robot is found within a spatially relative narrow application, for example based on the operating of a user program or based on manual operation, it is then possible for the industrial robot in the second operating mode to again move out of the narrowed application without risk of collision in a quasi-backwards manner.

Preferentially only so many of the points assigned in the movement path are necessary, that is, for example discrete positions and as applicable orientations of the distinguished point, during the movement of the mechanism recorded in the first operating mode, whereby the control device can control the drive based on the movement path recorded in the memory in such a way that the mechanism moves along the recorded movement path against the movement direction in which the mechanism was moved during the first operating mode. In the case of the robotic arm as a mechanism, the recorded movement path may have information about the axis settings of the axes, that is, information about the relative settings of the individual links of the robotic arm relative to one another during the movement. Thereby there results in particular a “backwards travel” in the second operating mode. Thereby there may be various time differences between every two points in the memory during recording. Sufficient recordings of the points or the axis settings preferentially are thereby maintained so that the recording occurs in equidistant space intervals along the path traveled in the first operating mode. The space distance between two recording points or axis positions may be further preferred, depending on the path traveled by the actual curvature radius. It is expedient for the path in small curvature radii to be scanned in spatially small distances more so than in large curvature radii or on straight path sections.

Preferentially the memory is not simply played backwards during the second operating mode, but preferentially there is once again new planning of the velocity for the movement of the mechanism during the second operating mode based on the movement path stored in the memory. If applicable this may be done based on the various time intervals in the memory, or also may be necessary since braking and accelerating, for example based on friction, are not reverse copies of each other. That means, a “forward” travel movement path, that is, a movement of the mechanism in the first operating mode, must for some time still not be backward; thus in the second operating mode, it must be able to travel, for example, if the permissible maximum accelerations or delays are exceeded.

According to a variant of the inventive procedure, for the second operating mode a path planning is carried out based on the movement path recorded in the memory in order that in the second operating mode the machine can be controlled based on the path planning of the at least one drive using the control device in such a way that the mechanism, in particular the distinguished point along the movement path recorded in the memory, moves in the opposite movement direction along which the mechanism was moved during the first operating mode.

Thereby preferentially the control device is set up to perform path planning for the second operating mode based on the movement path recorded in the memory in order to control in the second operating mode the at least one drive of the machine based on the path planning in such a way that the mechanism, in particular the distinguished point along the movement path recorded in the memory, moves against the movement direction along which the mechanism was moved during the first operating mode.

It can also be planned that in the second operating mode the control device can control the drives based on the movement path recorded in the memory in such a way that the mechanism or its distinguished point moves back and forth along the recorded movement path.

According to a preferred embodiment of the inventive machine or of the inventive procedure, it is planned that in the second operating mode the control device can control the at least one drive for the movement of the mechanism or of the distinguished point, in particular of the robotic arm or of its tool center point, along the movement path recorded in the memory corresponding to a manual activation of the input means of an in particular input apparatus coupled or couplable with the input apparatus. The input apparatus is for example the programmable hand device described above. As an input means, preferentially a shift paddle, two pressure knobs, and/or two fields presented on a touch screen of the input apparatus are used. By corresponding manual activation of the input means, it can be achieved in the second operating mode that there is any desired back and forth to be traveled by the mechanism or by the designated point along the movement path recorded in the ring buffer.

The velocity of the movement of the mechanism in the second operating mode is preferentially different from the velocity of the movement of the mechanism or its distinguished point in the first operating mode. For example, if the movement path is recorded in the memory during the automatic operation, then preferentially the velocity with which the mechanism is moved in the second operating mode, in particular the robotic arm or its tool center point, is less, preferentially much less. The velocity of the movement of the mechanism, in particular of the robotic arm or its tool center point in the second operating mode, is preferentially assigned the velocity with which the mechanism, in particular the robotic arm or its tool center point, is moved in the manual procedure operation.

It can also be planned to stop or to end the recording of the movement path in the memory during the first operating mode, in particular based on an activation of an input means, whereby after the stopping or ending of the recording, the mechanism is moved further in the first operating mode. In the second operating mode, it can then be planned that the mechanism or its distinguished point automatically move closer at the beginning or at the end of the movement path recorded in the memory so that the mechanism or its distinguished point can be moved along the movement path recorded in the memory.

### BRIEF DESCRIPTION OF THE DRAWINGS

An example of an embodiment of the invention is given for example in the attached schematic drawings.

FIG. 1 depicts an industrial robot in perspective presentation, and

FIG. 2 depicts a programmable hand device for manual control of industrial robot.

### DETAILED DESCRIPTION

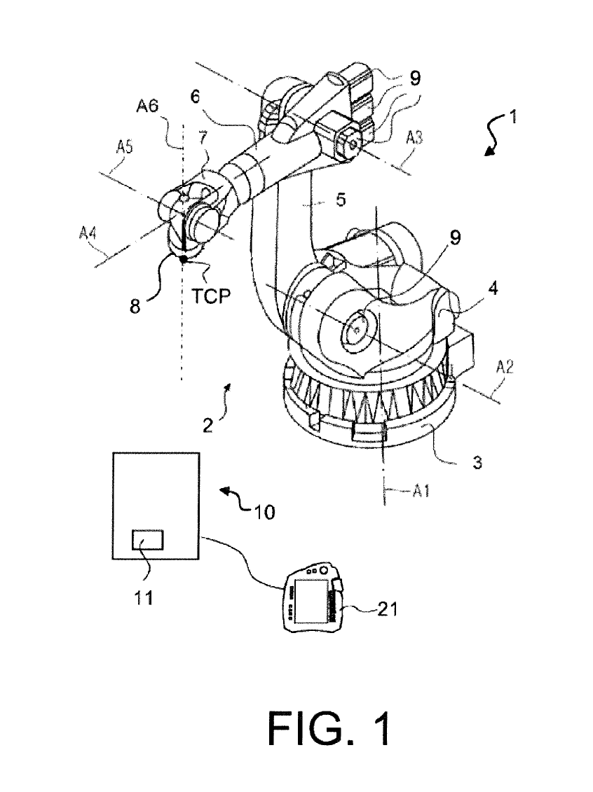

FIG. 1 shows an industrial robot 1 as an embodiment of a machine. The industrial robot 1 as a mechanism has a robotic arm 2, which in the case of the present embodiment comprises several links as components, set up behind one another and connected by joints. In the links there is in particular a stationary or movable frame 3 and a rotatable carousel 4, relative to the frame 3 with an axis running vertically A1. In the case of this embodiment, other links of the robotic arm 2 are a link arm 5, a boom 6, and a preferentially multi-axis robotic hand 7 with a for example fastening device assembled as a flange 8 to attach a terminal switch not further illustrated. The link arm 5 is pivotally mounted at its lower end, for example at a not further illustrated pivot bearing head on the carousel 4, around a preferentially horizontal axis A2. At the upper end of the link arm 5, the boom arm 6 is in turn pivotable about a preferably horizontal axis A3. At the end the boom arm 6 supports the robotic hand 7 with its preferentially three axes A4, A5, A6.

In order to move the industrial robot 1 or its robotic arm 2, generally known electric drives are included attached with a control device 10 (robot control). In FIG. 1, only some of the electric motors 9 of these electric drives are shown, which are fastened in or on the robotic arm 2. Power electronics of the electric drives are for example set up within a housing of a control cupboard not further described, in which for example the control device 10 is set up. The electric motors 9 in the case of this embodiment are alternating current motors, for example alternating current-synchronous motors. The power electronics may also be set up in and/or on the robotic arm 2.

A calculation program runs on the control device 10, what is called a user program, by means of which the control device 10 controls the drives in automatic operation, or if necessary regulates them, so that as a result the flange 8 of the industrial robot 1 or a tool center point TCP runs through a predefined movement. The drives are if applicable electrically controlled drives.

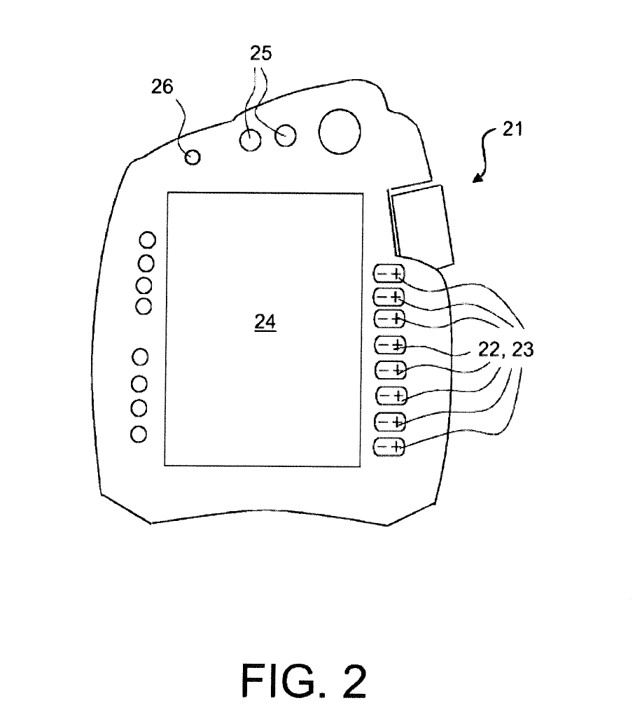

In the case of this embodiment, it is possible to operate the robotic arm 2 in manual operation, that is, through a manual procedure to move a programmable manual device 21 presented more specifically in FIG. 2. The programmable manual device 21 is connected with the control device 10 and comprises an input means 22. Upon activation of the input means 22, the control device 10 controls the drives of the industrial robot 1 in such a way that the flange 8 or the tool center point TCP of the robotic arm 2 perform a movement corresponding to the activation of the input means 22.

The input means 22 comprises for example shift paddles 23 and/or a joystick not further described.

The programmable manual device 21 may also have a display apparatus 24. If the display apparatus 24 is set up as a touch screen, then the touch screen can also be assembled as an input means of the programmable manual device 21, in which for example these display the shift paddles 23.

The programmable manual device 21 in the case of this embodiment may also be used for programming the industrial robot 1, that is, to create the user program.

In the case of this embodiment, the industrial robot 1 includes a memory set up as a ring memory or ring buffer 11, which in particular is connected with the control device 10 or a component of the control device 10. It is obvious that instead of the ring buffer 11 a memory set up in a different way can also be planned, for example as a LIFO stack or as a last in-first out memory, or some other dynamic memory. The ring buffer 11 is in particular set up in a way that it writes over the oldest recorded elements when rerunning.

In the case of this embodiment, the industrial robot 1 is set up to be operated in a first operating mode and in a second operating mode. In the first operating mode, the industrial robot 1 runs in automatic operation or in manual operation, that is, the robotic arm 1 is automatically moved either according to the user program running on the control device 1 or run manually using the programmable manual device 21. The desired operating mode may for example be activated by activating another input means 25 of the programmable manual device 21.

In the case of this embodiment, the industrial robot 1 or its control device 10 is set up in such a way that during the first operating mode the movement path laid down in discrete steps by the robotic arm 2 or its tool center point TCP is recorded continuously in the memory set up as a ring buffer 11. The scanning rate or the recording rate of the actual path can thereby lie preferred between 1 Hz and 10 kHz, in particular between 10 Hz and 100 Hz. Thereby the actual path traveled or recorded or scanned by the robotic arm 2, including any additional axes present, is preferentially written quasi-continuously in the ring buffer 11. In particular the recorded movement path includes information about the tool center points TCP moved by the robotic arm 2, in particular including information about the status, that is, the positions and orientations of the tool center point TCP during its movement. The recorded movement path may also contain information about the axis settings of axes A1-A6, that is, information about the relative settings of the individual links of the robotic arm 2 relative to one another during movement.

Thereby during the first operating movement the actual back laid movement path of the robotic arm 2 is recorded in the ring buffer 11 up to a specific length, which is the length given or predefined in the ring buffer 11.

There results thereby a recorded maximum path length, depending on the size of the assembled memory, preferentially configurable, as a ring buffer 11, around which the robotic arm 2 is now moved in the first operating mode.

If the industrial robot is now in its second operating mode, in which the industrial robot 2 for example can then be switched on, if the robotic arm 2 stands still, then it is planned that with the support of the movement path of the robotic arm 2 stored in the ring buffer 11 the control device 10 controls the robotic arm 2 in such a way that the arm can be moved back and forth along the recorded movement path, in particular using the programmable manual device 21. This occurs preferentially through the activation of the input means 22 of the programmable manual device 21, preferentially through activating one of the shift paddles 23. In particular it is then planned that as part of the movement path of the robotic arm 2 stored in the ring buffer 11, the robotic arm 2 can be moved back and forth along the recorded movement path through corresponding activation of the corresponding shift paddle 23. A movement backwards to the movement performed in the first operating mode can for example can be selected by pressing the operating part of the shift paddle 23 marked with a “−”, and a movement of the robotic arm 2 in the direction of the movement performed in the first operating mode can for example be selected by pressing the operating part of the shift paddle 23 marked with a “+”.

During the second operating mode, the laid down movement of the robotic arm 2 is not recorded in the ring buffer 11. In other words, recording of the current path in the ring buffer 11 occurs only in the first operating mode.

If the industrial robot 1 is in its second operating mode, then it is preferentially planned that the corresponding shift paddle 23 is automatically marked either for example by being illuminated or otherwise marked out.

During the second operating mode, in particular with the support of the movement path of the positions and orientations of the tool center point TCP or of the settings of axes A1-A6 of the robotic arm 2 as recorded in the ring buffer 11, including possibly present additional axes, after a possible thinning out of the information recorded in the ring buffer 11, a path is calculated by the control device 10, which for example represents the most recently traveled forward movement in the first operating mode, but in the reverse direction.

The velocity of the movement of the robotic arm 2 during the second operating mode occurs preferentially independently of the velocity of the robotic arm 2 during the first operating mode, in particular if the industrial robot 1 acts in automatic operation during the first operating mode.

The velocity with which the robotic arm 2 is moved in the second operating mode is preferentially dependent on the velocity and corresponds to the velocity with which the robotic arm 2 is moved during the manual operation.

During the second operating mode, in particular the robotic arm 2 moves by pressing the part of the corresponding shift paddle 23 marked with a “−” against the movement performed in the first operating mode, as long as the corresponding shift paddle 23 is activated or until the robotic arm 2 is moved along the maximum path length recorded in the ring buffer 11. When this path length is reached, preferentially the control device 10 stops the movement of the robotic arm 2 with a corresponding report.

In particular it is planned that if the shift paddle 23 is set in motion prior to this, that is if before reaching the end of the distinguished movement path, the part of the shift paddle 23 designated with the “−” can no longer be activated, the movement of the robotic arm 2 also stops. By a subsequent activation of the shift paddle 23 during the second operating mode, the control device 10 continues to control the robotic arm 22 on the basis of the movement path stored in the ring buffer 11, so that as a result this arm moves along the recorded movement path.

In the case of this embodiment, it is further planned that for example by pressing the part of the shift paddle 23 designated with the “+”, the robotic arm 2 based on the movement path stored in the ring buffer 11 can be moved in the direction set in the movement performed in the first operating mode. This occurs as long as the shift paddle 23 is activated, but at the most up until the reaching of the point on the recorded movement path at which the movement was ended in the first operating mode or at the point at which the recording of the movement path was ended in the ring buffer 11.

In this manner the forward and backward movement can be changed as often as desired along the recorded movement path.

In order to avoid repeat activity in carrying out the movement, in particular these movements performed in the second operating mode are the only movements that are not recorded or are incompletely recorded in the ring buffer 11.

In the case of this embodiment it is also planned that if the industrial robot 1 is switched from the second operating mode to the first operating mode, the part of the movement path recorded in the ring buffer 11, which actually would still have to be traveled in the second operating mode, at first stays recorded. On the other hand, the part of the movement path recorded in the ring buffer 11, which actually is available only by pressing the part of the shift paddle 23 designated with “+”, is deleted.

It can also be planned that during the first operating mode, in particular during the manual operation, the recording of the movement path in the ring buffer 11 can be the activated or stopped, in that for example an input means 26 of the program manual device 21 is activated, and the robotic arm 2 continues to be moved in the first operating mode. In the second operating mode it can then be planned that the robotic arm 2 or its tool center point TCP, controlled by the control device 10, are automatically brought closer to the beginning or the end of the movement path recorded in the ring buffer 11, so that the robotic arm 2 can be moved along the movement path recorded in the ring buffer 11.

Thereby the possibility arises of having a selected point travel along such a trajectory. One thereby has the possibility of offering manually a fixed trajectory that is freely definable but from a specific fixed point in time.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1-16. (Canceled)

17. A machine, comprising:
a mechanism comprising at least two components arranged relative to one another and movable with respect to at least one axis by at least one drive of the machine;
a memory; and
a control device communicating with the drive and the memory, the control device having at least first and second operating modes, whereby:
in the first operating mode, the control device controls the at least one drive to move the mechanism such that the mechanism moves along a movement path of the mechanism, and the control device stores the movement path in the memory, and
in the second operating mode, the control device controls the at least one drive based on a movement path stored in the memory such that the mechanism moves along the movement path that is stored in the memory.

18. The machine of claim 17, wherein the control device moves a predetermined point of the mechanism along the corresponding movement path in the first or second operating modes.

19. The machine of claim 17, wherein:
the machine is configured as an industrial robot;
the mechanism is configured as a robotic arm;
the at least two components comprise a plurality of serially arranged links of the robotic arm, the links connected by joints and movable about a plurality of axes by a plurality of the drives; and
the control device is configured such that:
in the first operating mode, the control device controls the plurality of drives for moving the robotic arm such that the robotic arm moves along the movement path and records the movement path in the memory, and
in the second operating mode, the control device controls the plurality of drives based on the movement path recorded in the memory such that the robotic arm moves along the movement path recorded in the memory.

20. The machine of claim 19, wherein the control device controls the plurality of drives such that a tool center point of the robotic arm moves along the movement path recorded in the memory.

21. The machine of claim 17, wherein at least one of:
the first operating mode is an automatic operation mode of the machine wherein the control device controls the at least one drive based on a user program running on the control device such that the mechanism moves along the movement path; or
the machine further comprises an input device coupled with the control device and having an input means, and the first operating mode facilitates a manual operation of the machine with the input device such that the control device controls the at least one drive to move the mechanism along the movement path corresponding to a manual actuation of the input means.

22. The machine of claim 17, wherein the control device is configured such that, in the second operating mode, the control device controls the at least one drive based on the movement path stored in the memory such that the mechanism moves along the stored movement path in a direction opposite to a direction that the mechanism was moved during the first operating mode.

23. The machine of claim 17, wherein the control device is configured such that, in the second operating mode, the control device controls the at least one drive based on the recorded movement path in the memory such that the mechanism moves back and forth along the recorded movement path.

24. The machine of claim 17, further comprising:
an input device communicating with the control device and having an input means;
wherein, in the second operating mode, the control device controls the at least one drive to move the mechanism along the movement path recorded in the memory corresponding to manual actuation of the input means.

25. The machine of claim 17, wherein the control device controls movement of the mechanism such that at least one of:
the velocity of the movement of the mechanism in the second operating mode differs from the velocity of the movement of the mechanism in the first operating mode; or
the velocity of the movement of the mechanism is set by a manual operation of the machine.

26. The machine of claim 17, wherein the control device is configured such that:
the recording of the current movement path in the memory during the first operating mode is ended by the activation of an input device, and then the mechanism is further moved by the controller; and
in the second operating mode, the controller automatically moves the mechanism to either the beginning or the end of the movement path recorded in the memory, such that the mechanism can move along the movement path recorded in the memory.

27. The machine of claim 17, wherein the memory is configured as a ring buffer or as a last in/first out (LIFO) memory.

28. A method for operating a machine, the machine comprising a control device and a mechanism that includes at least two components arranged relative to one another and movable with respect to at least one axis by at least one drive of the machine, the method comprising:
in a first operating mode of the machine, controlling the at least one drive with the control device such that the mechanism moves along a movement path, and simultaneously storing the movement path in a memory; and
in a second operating mode of the machine, controlling the at least one drive with the control device based on the movement path recorded in the memory such that the mechanism moves along the movement path that is stored in the memory.

29. The method of claim 28, wherein controlling the at least one drive with the control device such that the mechanism moves along a movement path comprises controlling the at least one drive to move a predetermined point of the mechanism along the movement path.

30. The method of claim 28, wherein:
the machine is configured as an industrial robot;
the mechanism is configured as a robotic arm;
the at least two components comprise a plurality of serially arranged links of the robotic arm, the links connected by joints and movable about a plurality of axes by a plurality of the drives; and
the predetermined point is a tool center point arranged on the robotic arm.

31. The method of claim 28, wherein at least one of:
automatically controlling the at least one drive with the control device in the first operating mode based on a user program running on the control device such that the mechanism moves along the movement path; or
controlling the at least one drive with the control device in the first operating mode to move the mechanism along the movement path corresponding to a manual actuation of an input device communicating with the control device.

32. The method of claim 28, comprising at least one of:
controlling the at least one drive with the control device in the second operating mode based on the movement path stored in the memory such that the mechanism moves along the stored movement path in a direction opposite to the direction that the mechanism was moved during the first operating mode; or
controlling the at least one drive with the control device in the second operating mode based on the movement path stored in the memory such that the mechanism moves back and forth along the stored movement path.

33. The method of claim 28, comprising controlling the at least one drive with the control device based on the movement path stored in the memory and based on the activation of an input means of an input device.

34. The method of claim 28, comprising at least one of:
moving the mechanism along the movement path stored in the memory in the second operating mode with a velocity that is different from a velocity of the movement of the mechanism in the first operating mode; or
moving the mechanism along the movement path stored in the memory in the second operating mode with the velocity that is determined by a velocity of the mechanism in manual operation.

35. The method of claim 28, comprising:
ending the storing of the current movement path in the memory during the first operating mode in response to an activation of an input device, then further moving the mechanism with the controller; and
automatically moving the mechanism with the controller in the second operating mode to either the beginning or the end of the movement path stored in the memory, such that the mechanism can move along the movement path stored in the memory.
